(19) United States
(12) Patent Application Publication
(10) Pub. No.: US 2024/0263082 A1
(43) Pub. Date: Aug. 8, 2024

(54) A STORAGE TANK SYSTEM AND A METHOD FOR REDUCING UNWANTED GAS FORMATION

(71) Applicant: Neste Oyj, Espoo (FI)

(72) Inventors: Jarmo HALTTUNEN, Espoo (FI); Ville MYKRÄ, Espoo (FI)

(73) Assignee: Neste Oyj, Espoo (FI)

(21) Appl. No.: 18/566,162

(22) PCT Filed: Jun. 2, 2022
(86) PCT No.: PCT/FI2022/050376

§ 371 Date: Dec. 1, 2023

(30) Foreign Application Priority Data
Jun. 3, 2021 (FI) 20215646

(51) Int. Cl. C10G 3/00; C02F 1/40; C02F 11/121; C10G 45/58; C11B 3/00; C11B 3/16

(52) U.S. Cl. CPC C10G 3/50; C02F 1/40; C02F 11/121; C10G 45/58; C11B 3/008; C11B 3/16; C02F 2209/02

(57) ABSTRACT

A storage tank system includes a storage tank for storing biological feedstock, a filtering system configured to separate sludge from the biological feedstock, and a water separator configured to separate water from the biological feedstock. A material transfer system transfers biological feedstock from the lower portion of the storage tank via the filtering system to the water separator and, from the water separator, residual biological feedstock from which water has been removed at least partially back to the storage tank. The removal of water reduces unwanted gas generation by microbiological reactions, and safety of the storage tank system is improved.

### FIELD OF THE DISCLOSURE

The disclosure relates generally to handling of biological material containing biological feedstock, such as low-quality animal fat or plant oil, suitable for renewable hydrocarbon production. More particularly, the disclosure relates to a method for reducing unwanted gas formation, such as hydrogen formation, inside a storage tank containing biological feedstock. Furthermore, the disclosure relates to a storage tank system for storing biological feedstock. Furthermore, the disclosure relates to a method and a system for producing renewable hydrocarbons from biological feedstock.

### BACKGROUND

Oil refining into hydrocarbons suitable for fuel and chemical applications, for example diesel or aviation fuel, from renewable biological material is becoming more and more important for the fuel industry. The biological material may comprise different types and grades of fats and oils, or residues and wastes thereof. Typically, suitable biological material containing biological feedstock is acquired from several different sources, stored, transported to a production site, and purified before feeding into oil refining facilities for production of hydrocarbons. In many cases, the biological material that contains biological feedstock suitable for renewable hydrocarbon production is stored in storage tanks at elevated temperature for a varying storage period.

During the storage period, water is typically separated from the biological material and accumulated into the lower part of a storage tank so that an aqueous phase is formed, and the upper part of the storage tank contains the fatty or oily phase i.e. the biological feedstock. Free water contained in the aqueous phase enables growth of microorganisms, such as bacteria, generating unwanted gas at anaerobic conditions. The formed gas is carried into the upper part of the storage tank, and the formed gas may be flammable, explosive, poisonous, and/or corrosive, and thereby prone to cause safety problems. The formed gas may comprise, for example, hydrogen H₂, methane CH₄, carbon monoxide CO and/or other unwanted gaseous substances.

As an example, a gas space of a full storage tank for storing biological feedstock can be as large as 300 m³ and the generated hydrogen content may occasionally exceed the lower explosion limit “LEL” of hydrogen in the gas space. Therefore, the amount of energy that is abruptly released in a possible hydrogen explosion is so high that severe damages would ensue.

It is important to take precautionary measures to alleviate or even remove the possibility for safety issues of the kind mentioned above.

### SUMMARY

The following presents a simplified summary in order to provide a basic understanding of some embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new method for reducing unwanted gas formation inside a storage tank which contains biological material containing biological feedstock for renewable hydrocarbon production and in which at least one microorganism produces unwanted gas in the presence of an aqueous phase typically originating from the biological material. The biological feedstock may comprise various types and grades of animal fats and oils, plant fats and oils, and/or fish fats and oils, and/or wastes and residues thereof. In this document the word “fat” is used to also cover fatty materials which are pumpable with commercially available pumps in e.g. room temperature. The unwanted gas may comprise flammable, explosive, poisonous, and/or corrosive gas prone to cause safety problems and originating from interaction of the microorganism with the components of the biological material.

In a method according to the invention, the amount of the above-mentioned aqueous phase contained by the storage tank is reduced by at least partial removal of the aqueous phase from the storage tank.

The method according to the invention removes free water in the form of an aqueous phase formed from the storage tank, and thereby growth and activity of the microorganisms, such as bacteria and/or other microbes that generate unwanted gas, like hydrogen, is inhibited. As a corollary, unwanted gas formation inside the storage tank is reduced and thereby the safety of the storage tank system is improved.

In accordance with the invention, there is also provided a new method for producing renewable hydrocarbons from biological feedstock. The method comprises:
receiving biological material at a storage tank containing, after receiving the biological material, the biological feedstock for producing the renewable hydrocarbons, sludge, an aqueous phase, and at least one microorganism generating unwanted gas,
carrying out a method according to the invention for reducing unwanted gas formation inside the storage tank, and
producing the renewable hydrocarbons from the biological feedstock taken out from the storage tank, the producing the renewable hydrocarbons may comprise for example hydrodeoxygenation and/or isomerisation.

In accordance with the invention, there is also provided a new storage tank system for storing biological feedstock. A storage tank system according to the invention comprises:
a storage tank for storing biological feedstock,
a filtering system,
a water separator, and
a material transfer system configured to:
   transfer a portion comprising at least part of an aqueous phase, part of the biological feedstock, and at least part of sludge contained by the storage tank from a lower part of the storage tank to the filtering system configured to separate at least part of the sludge from the portion,
   transfer the filtered portion from the filtering system to the water separator configured to separate at least part of the aqueous phase from the filtered portion, and
   transfer, from the water separator back to the storage tank, residual of the filtered portion from which the aqueous phase has been at least partially removed.

In accordance with the invention, there is also provided a new system for producing renewable hydrocarbons from biological feedstock. A system according to the invention comprises:
one or more storage tank systems according to the invention,
an inlet system configured to supply biological material to one or more storage tanks of the one or more storage tank systems, the one or more storage tanks containing, after the supplying the biological material, the biological feedstock for producing the renewable hydrocarbons, sludge, an aqueous phase, and at least one microorganism capable of generating unwanted gas,
an oil refinery configured to produce the renewable hydrocarbons from the biological feedstock, and
a delivery system configured to deliver the biological feedstock from the one or more storage tank systems to the oil refinery.

Exemplifying and non-limiting embodiments of the invention are described in accompanied dependent claims.

Various exemplifying and non-limiting embodiments of the invention both to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features.

The features recited in the accompanied dependent claims are mutually freely combinable unless otherwise explicitly stated.

Furthermore, it is to be understood that the use of “a” or “an”, i.e. a singular form, throughout this document does as such not exclude a plurality.

### BRIEF DESCRIPTION OF THE FIGURES

Exemplifying and non-limiting embodiments of the invention and their advantages are explained in greater details below in the sense of examples and with reference to the accompanying drawings, in which:

FIG. 1 illustrates a storage tank system according to an exemplifying and non-limiting embodiment,

FIG. 2 illustrates a storage tank system according to another exemplifying and non-limiting embodiment,

FIG. 3 illustrates a system according to an exemplifying and non-limiting embodiment for producing renewable hydrocarbons, and

FIG. 4 shows a flowchart of a method according to an exemplifying and non-limiting embodiment for reducing unwanted gas formation inside a storage tank that contains biological feedstock.

### DESCRIPTION OF EXEMPLIFYING EMBODIMENTS

The specific examples provided in the description below should not be construed as limiting the scope and/or the applicability of the accompanied claims. Lists and groups of examples provided in the description are not exhaustive unless otherwise explicitly stated.

Biological material as used herein refers to material collected from various sources and of varying quality. When using waste and residue materials in addition to the components that can be used as biological feedstock, the biological material may further include a wide variety of materials not suitable, or typically harmful, for further processing, such as water, metal impurities, microbes, pieces of bone, fur, hair, plastic flakes, pieces of rubber gloves, polyethylene, gelatines and proteines, chlorine components, salts, and the like.

The biological material suitable for further processing may comprise crude, refined or waste qualities of plant and/or vegetable oils and/or microbial oils may include babassu oil, carinata oil, soybean oil, canola oil, coconut oil, rapeseed oil, crude tall oil “CTO”, tall oil “TO”, tall oil fatty acid “TOFA”, tall oil pitch “TOP”, palm oil “PO”, palm oil fatty acid distillate “PFAD”, technical corn oil (TCO), jatropha oil, palm kernel oil, sunflower oil, castor oil, camelina oil, archaeal oil, bacterial oil, fungal oil, protozoal oil, algal oil, seaweed oil, oils from halophiles, and mixtures of any two or more thereof. Animal fats and/or oils may include crude, refined or waste qualities of inedible tallow, edible tallow, technical tallow, flotation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof. These oils and/or fats typically comprise C10-C24 fatty acids and derivatives thereof, including esters of fatty acids, glycerides, i.e. glycerol esters of fatty acids. The glycerides may specifically include monoglycerides, diglycerides and triglycerides.

The biological feedstock or renewable feedstock as used herein refers to feedstock derived from the biological material. The sources for renewable feedstock are numerous including oils and/or fats, usually containing lipids (e.g. fatty acids or glycerides), such as plant oil/fats, vegetable oil/fats, animal oil/fats, algae oil/fats, fish oil/fats, or oil/fats from other microbial processes, for example, genetically manipulated algae oil/fats, genetically manipulated oil/fats from other microbial processes and also genetically manipulated vegetable oil/fats. Components of these materials may also be used, for example, alkyl esters, typically C1-C5 alkyl esters, such as methyl, ethyl, propyl, iso-propyl, butyl, sec-butyl esters, or olefins. Additionally, the renewable feedstock may include C1-C5 alkyl alcohols, particularly methyl, ethyl, propyl, iso-propyl, butyl, and/or sec-butyl esters of fatty acids, and any combinations thereof.

The biological feedstock may additionally include free fatty acids, fatty acid esters, including mono-, di-, and triglycerides, or combinations thereof. The biological feedstock is typically pretreated before entering it into the refining process for removal of several different impurities and to meet the processing specifications in terms of e.g. phosphorus, total metals and sodium, potassium, magnesium, calcium, iron, and copper impurities. Typical pretreatment methods include e.g. degumming, bleaching and deodorizing.

In one exemplifying and non-limiting embodiment, the biological feedstock includes waste and residue material originating from animal fat/oil, such as animal fat “AF”, plant fat/oil such as palm oil and derivatives thereof, such as palm effluent sludge “PES”, and used cooking oil “UCO”. PES typically is collected from the wastewater ponds of the palm mills. PES typically has high portion of free fatty acids “FFA”, ˜50 . . . 80%, and for this reason a high amount of impurities like metals in the form of divalent/trivalent soaps. Because of its origin the PES feedstock material usually contains several types of microbes that can produce unwanted gases like methane.

Animal fat may contain a wide variety of impurities like solids, e.g. pieces of bone, fur, hair, plastic flakes, pieces of rubber gloves. There can also be metals and other impurities bonded to the fat molecules. Other impurities may comprise polyethylene that is dissolved to the fat, gelatines and proteins. Depending on the rendering method used for producing animal fats it may also contain microbes that can produce unwanted gases like methane, carbon monoxide and hydrogen. The slaughterhouse waste of animal origin containing animal fat, such as lard or tallow, is typically dry or wet rendered, preceding the storage in a storage tank. The fat always further contains inherent water or moisture mixed or bound into the fat. Thus, there will be some hydrolysis of triglycerides gradually taking place in a storage tank, together with a slow separation of water from the tissue or fat. This separation may take from a few days to several months, such as from 3 days to even 6 months. Used cooking oil may contain solid impurities like proteins, crumbs and other pieces of the food that has been cooked with the oil. There may further be excess amounts of chlorine in the form of salt or organic chlorine compounds.

The ¹⁴C-isotope content can be used as evidence of the renewable or biological origin of a feedstock, raw material, or product. Carbon atoms of renewable material comprise a higher number of unstable radiocarbon ¹⁴C atoms compared to carbon atoms of fossil origin. Therefore, it is possible to distinguish between carbon compounds derived from biological sources, and carbon compounds derived from fossil sources by analysing the ratio of the ¹²C and ¹⁴C isotopes. Thus, a particular ratio of said isotopes can be used to identify renewable carbon compounds and differentiate those from non-renewable i.e. fossil carbon compounds. The isotope ratio does not change in chemical reactions. An example of a suitable method for analysing the content of ¹⁴C carbon from biological sources is ASTM D6866 (2020). An example of how to apply ASTM D6866 to determine the renewable content in fuels is provided in the article of Dijs et al., Radiocarbon, 48(3), 2006, pp 315-323. For the purpose of the present invention, a carbon-containing material, such as raw material, feedstock or product, is considered to be of renewable origin if it contains 90% or more modern carbon pMC, such as about 100% modern carbon, as measured using ASTM D6866.

Processing of renewable hydrocarbons suitable for use as renewable fuels or renewable chemicals from biological feedstock involves refining of the biological feedstock at an oil refinery. Typically, the oil refining process includes pretreatment of the crude biological feedstock to meet the purity requirements for the processing. The processing includes preferably hydrotreatment of the purified biological feedstock into hydrocarbons using catalytic processes. Preferably, hydrotreatment includes catalytic hydrodeoxygenation combined with catalytic isomerisation, such as hydroisomerisation. The oxygen removal by hydrodeoxygenation and branching of the hydrocarbons by isomerisation may be performed simultaneously or in sequence, and may further include other processing steps, such as decarboxylation, decarbonylation or hydrocracking for carbon chain length reduction or hydrofinishing for removal of remaining impurities.

By the term “tank” is meant herein an industrial scale container, such as a vertical cylindrical container, the size of which is typically from 300 m³ to 15000 m³.

By the term “sludge” is meant herein material which contains a mixture of fat/oil and water, and from which the fat/oil and the water separates and settles with time. Moreover, the sludge typically contains small amounts of solid material, such as solid particles e.g. sand, phosphates, bones, and the like; and plastics. This sludge may comprise a high percentage, such as about 50%, of usable fat/oil.

By the term “hydrotreatment” is meant herein a catalytic processing of organic material by all means of molecular hydrogen. Preferably, hydrotreatment removes oxygen from organic oxygen containing compounds as water i.e. by hydrodeoxygenation “HDO”. Additionally or alternatively, hydrotreatment may remove sulphur from organic sulphur containing compounds as hydrogen sulphide H₂S, i.e. by hydrodesulphurisation “HDS”, it may further remove nitrogen from organic nitrogen containing compounds as ammonia NH₃, i.e. by hydrodenitrofication “HDN”, and/or it may remove halogens, for example chlorine, from organic chloride containing compounds as hydrochloric acid HCl, i.e. by hydrodechlorination “HDCl”. It may further remove aromatic compounds by hydrodearomatisation “HDA”.

By the term “hydrodeoxygenation”, HDO, is meant herein hydrodeoxygenation of feedstock of biological origin, such as feedstock comprising triglycerides or other fatty acid derivatives or fatty acids. It is the removal of carboxyl oxygen as water by means of molecular hydrogen under the influence of a catalyst. The hydrodeoxygenation may be accompanied by hydrodesulphurisation, hydrodenitrification, and/or hydrodechlorination reactions.

By the term “isomerisation” is meant a reaction that causes branching of hydrocarbon chains of hydrotreated feedstock. Branching of hydrocarbon chains improves e.g. cold properties i.e. the isomerized hydrocarbons have better cold properties compared to merely hydrotreated feedstock. Better cold properties refer to e.g. a lower temperature value of a pour point or cloud point. The formed isoparaffins, also referred to as i-paraffins, may have one or more side chains, or branches, typically methyl or ethyl groups.

Typically, hydrodeoxygenation and isomerisation, such as hydroisomerisation, reactions take place in the presence of a catalyst suitable for the reaction. Reaction conditions and catalysts typically used in the hydrodeoxygenation of biological feedstock and in the isomerisation of resultant n-paraffins are disclosed in several documents. Examples of such processes are presented in e.g. FI100248, examples 1-3, and in WO2007003709. Advantageously, the hydrodeoxygenation may be perfomed at 200-400° C., 20-150 bar, using a supported Pd, Pt, Ni, NiMo, CoMo or NiW catalyst, the support being alumina, zeolite, silica, or mixtures thereof. The hydroisomeration may advantageously be performed at 200-500° C., 2-15 MPa, in the presence of a metal from the Element Group VIII further containing SAPO-11 or SAPO-41 or ZSM-22 or ZSM-23 or ferrierite, and Pt or Pd or Ni, and alumina or silica.

Oils and/or fats of biological origin may include a single kind of oil, a single kind of fat, mixtures of different oils, mixtures of different fats, mixtures of oil/oils and fat/fats, fatty acids, glycerol, and/or mixtures of the above-mentioned. Typically, when waste and residue material are used, they already comprise mixtures of several components.

Before biological feedstock is entering pretreatment processes at an oil refinery, it is typically stored in storage tanks at a tank farm which may or may not be in the vicinity of the actual oil refinery. The biological material may be transported to the tank farm area from several different locations all over the world using all suitable methods for transportation, typically by trucks, railway carriages, or marine vessels. The tank farm comprises usually several storage tanks whereto the biological feedstock material is transported from feedstock vendors and wherefrom the biological feedstock is transported to the oil refinery.

Water behaves very differently with biological lipid materials than with fossil oil and fossil waste oil. For example, water is dissolved into biological lipid materials, i.e. resides as bound water inside biological lipid material and gradually forms free water by separating from the biological lipid material. This is not the case with fossil oil, wherefrom free water can be easily separated. Therefore, for example, a continuous separation approach where fossil oil is allowed to flow out from an upper surface of liquid containing the fossil oil and water is not appropriately applicable in a system for handling biological lipid materials because the water is slowly and gradually separating from biological lipid materials.

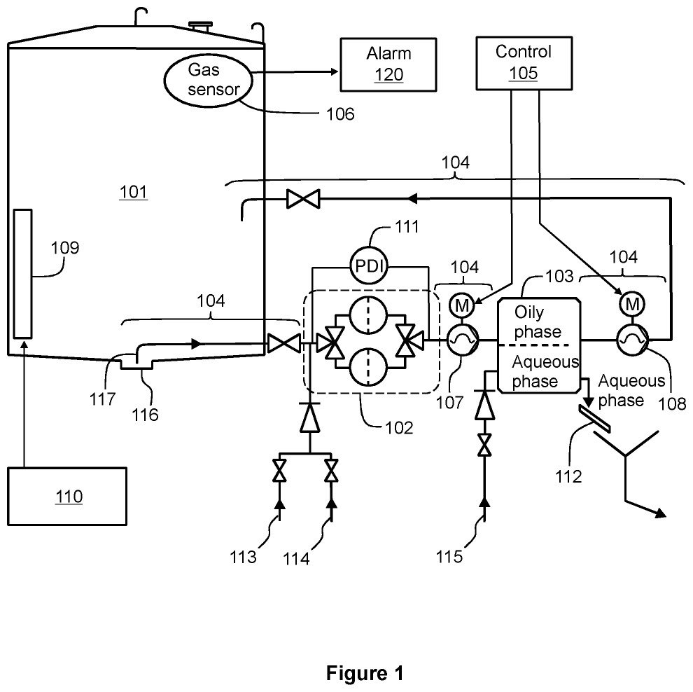

FIG. 1 illustrates a storage tank system according to an exemplifying and non-limiting embodiment. The storage tank system comprises a storage tank 101 for containing biological feedstock that may comprise various types and grades of animal fats and oils, plant fats and oils, and/or fish fats and oils, and/or wastes and residues thereof, and/or other renewable biological materials suitable for the subsequent manufacture into renewable hydrocarbons. Furthermore, the biological feedstock may comprise used cooking oil and/or palm effluent sludge. The volume of the storage tank 101 can be for example from 300 m³ to 15000 m³. The storage time may extend from just a few days to several months, depending on the quality and quantity of the biological material under consideration. In addition to the biological feedstock, the storage tank 101 contains an aqueous phase, sludge, and at least one microorganism capable of producing unwanted gas in the presence of the aqueous phase. The above-mentioned sludge is sludge containing water. The gas may comprise for example hydrogen H₂, methane CH₄, carbon monoxide CO, and/or other gaseous substances. The storage tank system comprises a filtering system 102 that can be provided with a pressure difference indicator “PDI” for indicating the condition of the filtering system 102, e.g. dirt deposit and blockages in the filtering system 102. The filtering system 102 may comprise for example one or more sieve filters and/or some other suitable filters. The storage tank system comprises a water separator 103 that can be for example such as ACO Grease separator Lipator-S-RA or Evac EcoTrap grease separator or some other suitable water separator device. In the exemplifying storage tank system illustrated in FIG. 1, the water outlet of the water separator 103 is provided with a spout 112 which enables visual inspection of water separation. In this exemplifying case, the water separator 103 comprises an inlet 115 for supplying fresh water to keep the water separator 103 in a proper operating status.

The storage tank system comprises a material transfer system 104 that is configured to remove from the lower part of the storage tank 101 a portion comprising at least part of the above-mentioned aqueous phase, part of the above-mentioned biological feedstock, and at least part of the above-mentioned sludge. In the exemplifying storage tank system illustrated in FIG. 1, the bottom of the storage tank comprises a recession 116 and the material transfer system 104 comprises a pipe 117 extending to the recession 116 from above and configured to remove the above-mentioned portion from the recession 116. The material transfer system 104 is configured to transfer the above-mentioned portion through the filtering system 102 that separates at least part of the sludge from the portion. Material that is separated by the filtering system 102 contains typically undesired solids, and thus the relative content of useful feedstock in the filtered portion is increased. The material transfer system 104 is configured to transfer the filtered portion from the filtering system 102 to the water separator 103 configured to separate at least part of the aqueous phase from the filtered portion. The material transfer system 104 is configured to transfer, from the water separator 103 back to the storage tank 101, residual of the filtered portion from which the aqueous phase has been at least partially removed. The above-described functionality removes from the storage tank 101 free water as well as bacteria and/or other microbes residing in the aqueous phase. Thereby amount, growth, and activity of bacteria and/or other microbes that generate unwanted gas e.g. hydrogen is reduced. As a corollary, unwanted gas formation inside the storage tank 101 is reduced and thereby the safety of the storage tank system is improved. In an advantageous final situation, the aqueous phase and sludge have been removed so well that substantially only the fatty and/or oily phases i.e. the biological feedstock is circulated by the material transfer system 104.

In the exemplifying storage tank system illustrated in FIG. 1, the material transfer system 104 comprises a first pump 107 between the filtering system 102 and the water separator 103. The first pump 107 is configured to transfer the portion from the storage tank 101 through the filtering system 102 to the water separator 103. The material transfer system comprises a second pump 108 between the water separator 103 and the storage tank 101. The second pump 108 is configured to transfer the residual of the filtered portion from the water separator 103 to the storage tank 101. Each of the first pump 107 and the second pump 108 can be for example a screw pump, a centrifugal pump, a progressive cavity pump, or some other suitable pump. An advantage of the above-described pump arrangement is that the first pump 107 does not need to handle solids which are removed by the filtering system 102 and the second pump 108 does not need to handle the aqueous phase removed by the water separator 103. This facilitates the operating conditions of the pumps. In the exemplifying storage tank system illustrated in FIG. 1, the material transfer system 104 comprises an inlet 113 for pressurized air for pipe cleaning and an inlet 115 for feeding water to the material transfer system 104. The pressurized air and the water can be used for e.g. removing unwanted material deposits from surfaces of the material transfer system 104.

A storage tank system according to an exemplifying and non-limiting embodiment comprises a control system 105 configured to activate the material transfer system 104 to transfer the above-mentioned portion through the filtering system 102 to the water separator 103 in accordance with a predetermined timing schedule. The predetermined timing schedule can be for example such that the pumps 107 and 108 are started a predetermined number of times per day, e.g. three times per day, for a suitable running period. The running period can be determined experimentally, and it can be varied depending on circumstances. The suitable running period can depend on for example the removed amount of water. For example, the pumps can be run as long as water is separated. In the exemplifying case illustrated in FIG. 1, the spout 112 enables visual inspection of water separation for determining a suitable running period. It is also possible that the pumps 107 and 108 are controlled manually. In a storage tank system according to an exemplifying and non-limiting embodiment, the control system 105 is configured to run the pumps 107 and 108 automatically according to a predetermined timing schedule, and the control system 105 comprises a user interface which allows manual control of the pumps 107 and 108, too. The control system 105 may comprise one or more processor circuits, each of which can be a programmable processor circuit provided with appropriate software, a dedicated hardware processor for example an application specific integrated circuit “ASIC”, or a configurable hardware processor for example a field programmable gate array “FPGA”. The control system 105 may comprise one or more memory circuits each of which can be e.g. a random access memory circuit “RAM”.

A storage tank system according to an exemplifying and non-limiting embodiment comprises a gas sensor 106 configured to measure concentration of one or more of the unwanted gases, e.g. hydrogen H₂, methane CH₄, and/or carbon monoxide CO, contained by the gas space of the storage tank 101. Furthermore, the storage tank system comprises an alarm system 120 configured to output an alarm signal in response to a situation in which one or more measured concentrations of one or more unwanted gases exceed its limit value. The alarm signal can be for example an acoustic signal, a light signal, and/or a data signal transmitted via a data transfer network to a receiver device, e.g. a mobile phone, of a worker and/or to a control and monitoring room. Advantageously, the control system 105 runs the pumps 107 and 108 in accordance with a predetermined timing schedule and, in addition, the alarm system is operating and the pumps 107 and 108 are manually controllable, too.

A storage tank system according to an exemplifying and non-limiting embodiment comprises a heater 109 configured to warm up the biological feedstock contained by the storage tank 101, and a temperature controller 110 configured to control the heater 109 to keep temperature of the biological feedstock between 50° C. and 95° C., more preferably between 53° C. and 90° C., and yet more preferably between 55° C. and 80° C. At a higher temperature, the viscosity of the fluid is lower and pumping is thus easier. Moreover, at a higher temperature, the water separation works better and the microbial activity is to some extent lowered. At a lower temperature, waxing may take place. The heater 109 may comprise for example heater tubes located inside the storage tank 101 and configured to conduct gaseous or liquid heating fluid e.g. water or steam.

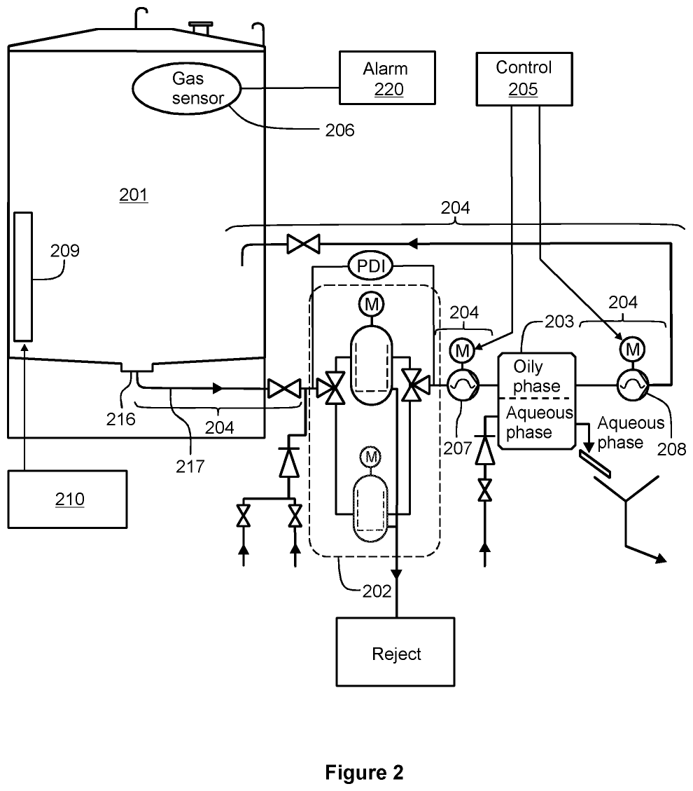

FIG. 2 illustrates a storage tank system according to an exemplifying and non-limiting embodiment. The storage tank system comprises a storage tank 201 for containing biological feedstock suitable for renewable hydrocarbon production. In addition to the biological feedstock, the storage tank 201 contains an aqueous phase, sludge, and at least one microorganism capable of generating unwanted gas which may comprise for example hydrogen H₂, methane CH₄, carbon monoxide CO, and/or other gaseous substances. The storage tank system comprises a filtering system 202 and a water separator 203. In this exemplifying case, the filtering system 202 comprises pressure screens which have a self-cleaning property. The self-cleaning property is advantageous especially in cases in which solids content of the biological material supplied to the storage tank 201 is high. The water separator 203 can be for example like the water separator 103 shown in FIG. 1.

The storage tank system comprises a material transfer system 204 that is configured to remove from the lower part of the storage tank 201 a portion comprising at least part of the above-mentioned aqueous phase, part of the above-mentioned biological feedstock, and at least part of the above-mentioned sludge. In this exemplifying case, the bottom of the storage tank comprises a recession 216 and the material transfer system 204 comprises a pipe 217 connected to the recession 216 from below and configured to remove the above-mentioned portion from the recession 216. The material transfer system 204 is configured to transfer the above-mentioned portion through the filtering system 202 that separates at least part of the sludge from the portion. The material transfer system 204 is configured to transfer the filtered portion from the filtering system 202 to the water separator 203 configured to separate at least part of the aqueous phase from the filtered portion. The material transfer system 204 is configured to transfer, from the water separator 203 back to the storage tank 201, residual of the filtered portion from which the aqueous phase has been at least partially removed. The above-described functionality removes from the storage tank 201 free water as well as microbes residing in the aqueous phase. Thereby, amount, growth, and activity of bacteria and/or other microbes that generate unwanted gas e.g. hydrogen is reduced. As a corollary, unwanted gas formation inside the storage tank 201 is reduced and thereby the safety of the storage tank system is improved.

In the exemplifying storage tank system illustrated in FIG. 2, the material transfer system 204 comprises a first pump 207 between the filtering system 202 and the water separator 203. The first pump 207 is configured to transfer the portion from the storage tank 201 through the filtering system 202 to the water separator 203. The material transfer system comprises a second pump 208 between the water separator 203 and the storage tank 201. The second pump 208 is configured to transfer the residual of the filtered portion from the water separator 203 to the storage tank 201. Each of the first pump 207 and the second pump 208 can be for example a screw pump, a centrifugal pump, a progressive cavity pump, or some other suitable pump.

A storage tank system according to an exemplifying and non-limiting embodiment comprises a control system 205 configured to activate the material transfer system 204 to transfer the above-mentioned portion through the filtering system 202 to the water separator 203 in accordance with a predetermined timing schedule. The predetermined timing schedule can be for example such that the pumps 207 and 208 are started a predetermined number of times per day, e.g. three times per day, for a suitable running period. It is also possible that the pumps are 207 and 208 are controlled manually. In a storage tank system according to an exemplifying and non-limiting embodiment, the control system 205 is configured to run the pumps 207 and 208 automatically according to a predetermined timing schedule, and the control system 205 comprises a user interface which allows manual control of the pumps 207 and 208, too.

A storage tank system according to an exemplifying and non-limiting embodiment comprises a gas sensor 206 configured to measure concentration of one or more unwanted gases, e.g. hydrogen H₂, methane CH₄, and/or carbon monoxide CO, contained by the gas space of the storage tank 201. Furthermore, the storage tank system comprises an alarm system 220 configured to output an alarm signal in response to a situation in which one or more measured concentrations of one or more unwanted gases exceed its limit value. The alarm signal can be for example an acoustic signal, a light signal, and/or a data signal transmitted via a data transfer network to a receiver device, e.g. a mobile phone, of a worker and/or to a control and monitoring room. Advantageously, the control system 205 runs the pumps 207 and 208 in accordance with a predetermined timing schedule and, in addition, the alarm system is operating and the pumps 207 and 208 are manually controllable, too.

A storage tank system according to an exemplifying and non-limiting embodiment comprises a heater 209 configured to warm up the biological feedstock contained by the storage tank and a temperature controller 210 configured to control the heater 209 to keep temperature of the biological feedstock between 50° C. and 95° C., more preferably between 53° C. and 90° C., and yet more preferably between 55° C. and 80° C. The heater 209 may comprise e.g. heater tubes located inside the storage tank 201 and configured to conduct gaseous or liquid heating fluid e.g. water or steam.

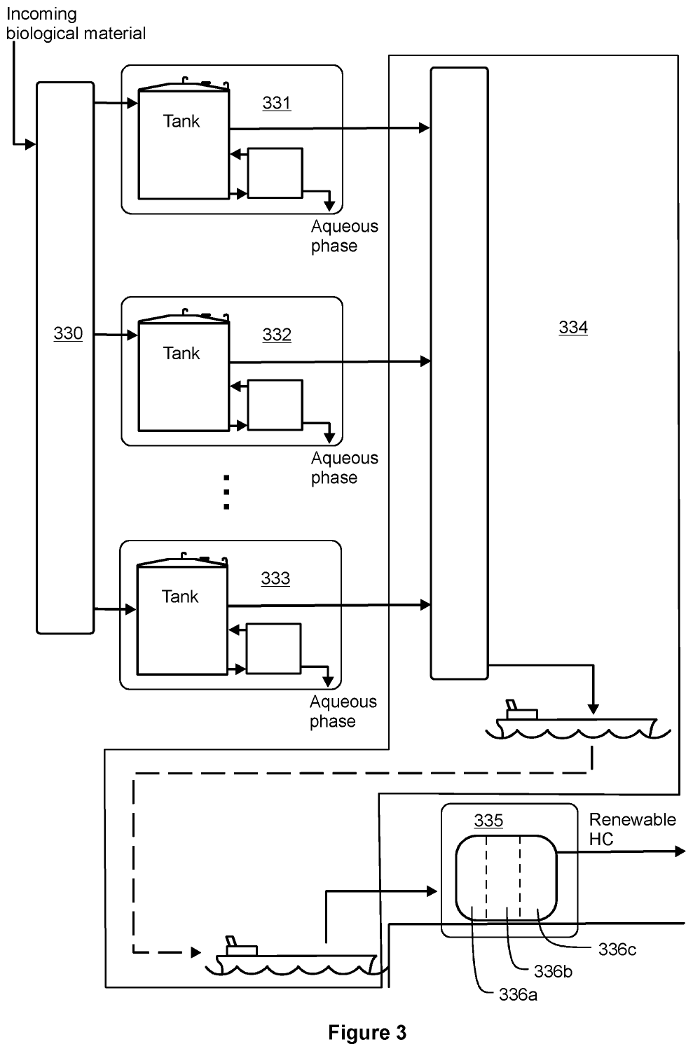

FIG. 3 illustrates a system according to an exemplifying and non-limiting embodiment for producing renewable hydrocarbons. The system comprises storage tank systems 331, 332, and 333 at least one of which is a storage tank system according to an embodiment of the invention. Each of the storage tank systems 331-333 can be for example like the storage tank system illustrated in FIG. 1 or like the storage tank system illustrated in FIG. 2. It is also possible that a system according to an exemplifying and non-limiting embodiment for producing renewable hydrocarbons comprises only one storage tank system.

The system illustrated in FIG. 3 comprises an inlet system 330 configured to supply biological material to storage tanks of the storage tank systems 331-333. After supplying the biological material to a storage tank, the storage tank contains biological feedstock for hydrocarbon production, an aqueous phase, sludge, and at least one microorganism capable of generating unwanted gas. The sludge can be formed in the storage tank when different impurities, such as dissolved plastics, solids, etc., deposit on the lower part of the storage tank. It is also possible that at least part of the sludge is formed in a transportation system which brings the biological material to the inlet system 330. The inlet system 330 may comprise for example means for unloading the biological material from trucks, railway carriages, and/or some other transportation devices and for loading the biological material to the storage tanks.

The system illustrated in FIG. 3 comprises an oil refinery 335 configured to produce the renewable hydrocarbons from the biological feedstock. The oil refinery 335 may comprise for example at least one pretreatment zone 336a, at least one hydrotreatment zone 336b configured to carry out hydrodeoxygenation, and at least one isomerisation zone 336c configured to carry out branching of the hydrocarbons produced by the hydrodeoxygenation.

The system comprises a delivery system 334 configured to deliver the biological feedstock from the storage tank systems 331-333 to the oil refinery 335. The delivery system 334 comprises means for unloading the biological feedstock from the storage tanks and for delivering the biological feedstock to the oil refinery 335. In this exemplifying case, the delivery system 334 comprises a ship connection between the storage tank systems 331-333 and the oil refinery 335. In a simple case the delivery system 334 may be just a pipeline, for example, if the storage tank systems 331-333 are in the vicinity of the refinery. The delivery system 334 may further comprise processing means for handling the biological feedstock prior to the ship connection, e.g. for purifying the biological feedstock and/or for producing a desired mix of biological feedstock batches unloaded from different ones of the storage tanks.

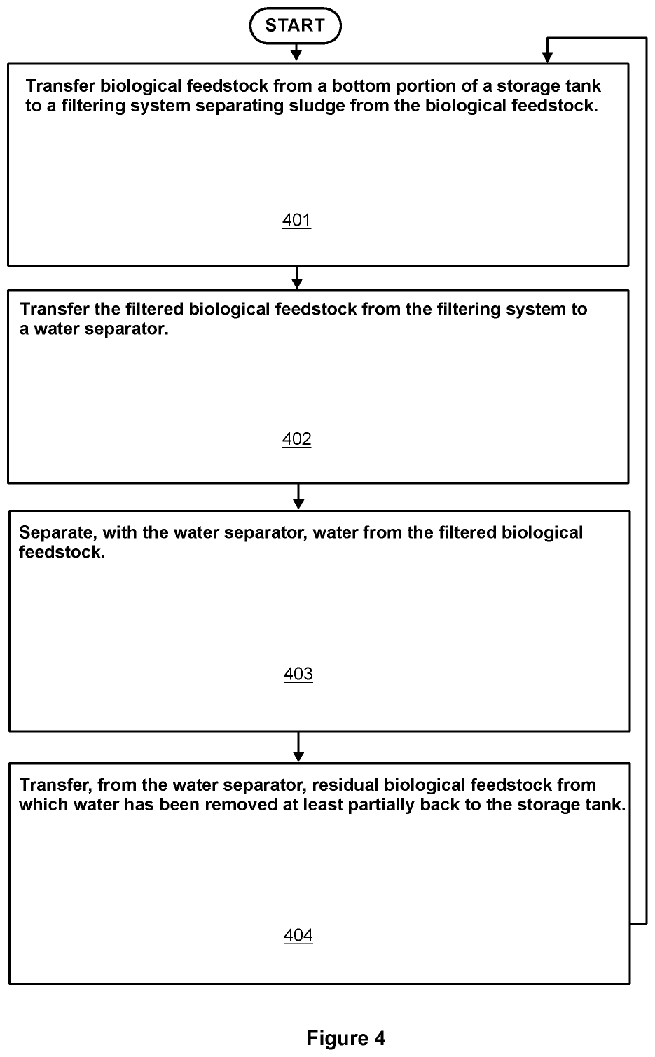

FIG. 4 shows a flowchart of a method according to an exemplifying and non-limiting embodiment for reducing unwanted gas formation inside a storage tank which contains biological feedstock for renewable hydrocarbon production and in which at least one microorganism produces unwanted gas in presence of an aqueous phase. The method comprises reducing the amount of the above-mentioned aqueous phase contained by the storage tank by at least partial removal of the aqueous phase from the storage tank. In the exemplifying embodiment illustrated in FIG. 4, the reducing the amount of the aqueous phase comprises:
action 401: transferring a portion comprising at least part of the aqueous phase, part of the biological feedstock, and at least part of sludge containing water and contained by the storage tank from the lower part of the storage tank to a filtering system separating at least part of the sludge from the portion,
action 402: transferring the filtered portion from the filtering system to a water separator,
action 403: separating, with the water separator, at least part of the aqueous phase from the filtered portion, and
action 404: transferring, from the water separator back to the storage tank, residual of the filtered portion from which the aqueous phase has been at least partially removed.

In an advantageous final situation, the above-mentioned aqueous phase and sludge have been removed so well that substantially only the fatty and/or oily phases i.e. the biological feedstock is circulated through the filtering system and the water separator.

In a method according to an exemplifying and non-limiting embodiment, the unwanted gas comprises at least one of the following: hydrogen H₂, methane CH₄, and/or carbon monoxide CO. In many cases, the unwanted gas contains hydrogen, or is hydrogen.

In a method according to an exemplifying and non-limiting embodiment, the biological feedstock comprises at least one of the following: animal fat, animal oil, plant fat, plant oil, fish fat, fish oil, used cooking oil, and/or palm effluent sludge.

In a method according to an exemplifying and non-limiting embodiment, the transferring 401 the above-mentioned portion through the filtering system to the water separator is carried out in accordance with a predetermined timing schedule.

A method according to an exemplifying and non-limiting embodiment comprises measuring concentration of one or more of the unwanted gases contained by the storage tank and generating an alarm signal in response to a situation in which the measured concentration of the one or more unwanted gases exceeds its limit value.

A method according to an exemplifying and non-limiting embodiment comprises using a first pump between the filtering system and the water separator to transfer the above-mentioned portion from the storage tank through the filtering system to the water separator and using a second pump between the water separator and the storage tank to transfer the above-mentioned residual of the filtered portion from the water separator to the storage tank. An advantage of the above-described pump arrangement is that the first pump does not need to handle solids which are removed by the filtering system and the second pump does not have to handle the aqueous phase removed by the water separator. This facilitates the operating conditions of the pumps.

In a method according to an exemplifying and non-limiting embodiment, the bottom of the storage tank comprises a recession and the method comprises transferring the portion from the recession.

A method according to an exemplifying and non-limiting embodiment comprises warming up the biological feedstock contained by the storage tank and controlling temperature of the biological feedstock to be between 50° C. and 95° C., more preferably between 53° C. and 90° C., and yet more preferably between 55° C. and 80° C.

A method according to an exemplifying and non-limiting embodiment for producing renewable hydrocarbons suitable for fuel and chemical applications from biological feedstock comprises:
receiving biological material at a storage tank containing, after receiving the biological material, the biological feedstock for producing the renewable hydrocarbons, sludge, an aqueous phase, and at least one microorganism generating unwanted gas,
carrying out a method according to an embodiment of the invention for reducing unwanted gas formation inside the storage tank, and
producing the renewable hydrocarbons from the biological feedstock taken out from the storage tank.

The producing the renewable hydrocarbons may comprise for example pretreatment and hydrodeoxygenation of the biological feedstock and branching of hydrocarbons produced by the hydrodeoxygenation.

The specific examples provided in the description given above should not be construed as limiting. Therefore, the invention is not limited merely to the exemplifying and non-limiting embodiments described above. Lists and groups of examples provided in the description are not exhaustive unless otherwise explicitly stated.

1. A method for reducing unwanted gas formation inside a storage tank, the method comprising:
providing a storage tank containing biological feedstock for renewable hydrocarbon production, wherein at least one microorganism produces unwanted gas in a presence of an aqueous phase; and
reducing an amount of the aqueous phase contained by the storage tank by at least partial removal of the aqueous phase from the storage tank.

2. A method according to claim 1, wherein the reducing the aqueous phase contained by the storage tank comprises:
transferring a portion containing at least part of the aqueous phase, at least part of sludge contained by the storage tank, and part of the biological feedstock from a lower part of the storage tank to a filtering system separating at least part of the sludge from the portion- to product a filtered portion;
transferring the filtered portion from the filtering system to a water separator,
separating, with the water separator, at least part of the aqueous phase from the filtered portion; and
transferring, from the water separator back to the storage tank, a residual of the filtered portion from which the aqueous phase has been at least partially removed.

3. A method according to claim 1, wherein the reduced gas formation is of a specified unwanted gas which comprises at least one or more of the following:
hydrogen, methane, and/or carbon monoxide.

4. A method according to claim 1, wherein the biological feedstock comprises at least one or more of the following:
animal fat, animal oil, plant fat, plant oil, fish fat, fish oil, used cooking oil, and/or palm effluent sludge.

5. A method according to claim 2, wherein the transferring the portion through the filtering system to the water separator is carried out in accordance with a predetermined timing schedule.

6. A method according to claim 1, wherein the method comprises;
using a first pump between the filtering system and the water separator to transfer the portion from the storage tank through the filtering system to the water separator and using a second pump between the water separator, and the storage tank to transfer the residual of the filtered portion from the water separator to the storage tank.

7. A method according to claim 1, wherein a bottom of the storage tank includes a recession and the method comprises;
transferring the portion from the recession.

8. A method according to claim 1, wherein the method comprises:
warming up the biological feedstock contained by the storage tank and controlling temperature of the biological feedstock contained by the storage tank to be between 50° C. and 95° C.

9. A method for producing renewable hydrocarbons from biological feedstock, the method comprising:
receiving biological material at a storage tank containing, after receiving the biological material, the biological feedstock for producing the renewable hydrocarbons, sludge, an aqueous phase, and at least one microorganism generating gas;
reducing gas formation inside the storage tank; and
producing the renewable hydrocarbons from the biological feedstock taken out from the storage tank;
wherein the method for reducing the gas formation inside the storage tank includes reducing an amount of the aqueous phase contained by the storage tank by at least partial removal of the aqueous phase from the storage tank.

10. A method according to claim 9, wherein the producing the renewable hydrocarbons comprises;
pretreatment and hydrodeoxygenation of the biological feedstock and branching of hydrocarbons produced by the hydrodeoxygenation.

11. A storage tank system comprising:
a storage tank for storing biological feedstock and containing at least one microorganism capable of producing gas in a presence of an aqueous phase contained by the storage tank, wherein the storage tank system includes
a filtering system;
a water separator; and
a material transfer system configured to:
transfer a portion containing at least part of the aqueous phase, at least part of sludge contained by the storage tank, and part of the biological feedstock from a lower part of the storage tank to the filtering system configured to separate at least part of the sludge from the portion to produce a filtered portion;
transfer the filtered portion from the filtering system to the water separator configured to separate at least part of the aqueous phase from the filtered portion, and
transfer, from the water separator back to the storage tank, a residual of the filtered portion from which the aqueous phase has been at least partially removed.

12. A storage tank system according to claim 11, wherein the storage tank system comprises;
a control system configured to activate the material transfer system to transfer the portion through the filtering system to the water separator in accordance with a predetermined timing schedule.

13. A storage tank system according to claim 11, wherein the material transfer system comprises;
a first pump between the filtering system and the water separator and configured to transfer the portion from the storage tank through the filtering system to the water separator; and
a second pump between the water separator and the storage tank and configured to transfer the residual of the filtered portion from the water separator to the storage tank.

14. A storage tank system according to claim 11, wherein a bottom of the storage tank includes a recession, and the material transfer system comprises;
a pipe extending to the recession and configured to remove the portion from the recession.

15. A storage tank system according to claim 11, wherein the storage tank system comprises;
a heater configured to warm up the biological feedstock contained by the storage tank; and
a temperature controller configured to control the heater to keep a temperature of biological feedstock contained by the storage tank between 50° C. and 95° C.

16. A system for producing renewable hydrocarbons, the system comprising:
one or more storage tank systems;
an inlet system configured to supply biological material to one or more storage tanks of the one or more storage tank systems, the one or more storage tanks containing, after a supplying of biological material, biological feedstock for producing the renewable hydrocarbons, sludge, an aqueous phase, and at least one microorganism capable of producing gas;
an oil refinery configured to produce renewable hydrocarbons from the biological feedstock; and
a delivery system configured to deliver biological feedstock from the one or more storage tank systems to the oil refinery;
wherein each of the one or more storage tank systems includes:
a storage tank for storing the biological feedstock and configured for containing at least one microorganism capable of producing unwanted gas in a presence of the aqueous phase contained by the storage tank;
a filtering system;
a water separator; and
a material transfer system configured to:
transfer a portion containing at least part of the aqueous phase, at least part of sludge contained by the storage tank, and part of the biological feedstock from a lower part of the storage tank to the filtering system configured to separate at least part of the sludge from the portion to produce a filtered portion;
transfer the filtered portion from the filtering system to the water separator configured to separate at least part of the aqueous phase from the filter portion; and
transfer, from the water separator back to the storage tank, a residual of the filtered portion from which the aqueous phase has been at least Partially removed.

17. A system according to claim 16, wherein the oil refinery comprises;
at least one pretreatment zone;
at least one hydrotreatment zone configured to carry out hydrodeoxygenation; and
at least one isomerisation zone configured to carry out branching of hydrocarbons produced at the hydrodeoxygenation zone.

18. A method according to claim 2, wherein the unwanted gas comprises:
at least one or more of the following: hydrogen, methane, and/or carbon monoxide.

19. A method according to claim 2, wherein the biological feedstock comprises at least one or more of the following:
animal fat, animal oil, plant fat, plant oil, fish fat, fish oil, used cooking oil, and/or palm effluent sludge.

20. A method according to claim 2, wherein the transferring the portion through the filtering system to the water separator is carried out in accordance with a predetermined timing schedule.
